(19) United States
(12) Patent Application Publication
(10) Pub. No.: US 2019/0203722 A1
(43) Pub. Date: Jul. 4, 2019

(54) ANTI-BLOCKING LIGHT SEWAGE PUMP WITHOUT COOLING OIL

(71) Applicant: GP Enterprises Co., Ltd, Jiangsu (CN)

(72) Inventor: Xian Wang, Suzhou, Jiangsu (CN)

(73) Assignee: GP Enterprises Co., Ltd, Suzhou, Jiangsu (CN)

(21) Appl. No.: 15/752,246

(22) PCT Filed: Jun. 13, 2017
(86) PCT No.: PCT/CN2017/088163

§ 371 Date: Feb. 12, 2018

(30) Foreign Application Priority Data
May 23, 2017 (CN) 201720575969.0

(51) Int. Cl. F04D 13/06; F04D 29/22; F04D 29/42; F04D 29/70; B01D 29/03

(52) U.S. Cl. CPC F04D 13/06; F04D 29/22; B01D 29/03; F04D 29/70; F04D 29/42

(57) ABSTRACT

An anti-blocking light sewage pump without cooling oil is described in the present application, comprises a motor housing, a motor, a funnel-shaped pump body, an anti-blocking impeller made of flexible rubber, and a filter screen. The motor and the funnel-shaped pump body are arranged in the motor housing, the anti-blocking impeller made of flexible rubber is arranged in said funnel-shaped pump body, said anti-blocking impeller made of flexible rubber is coaxially connected with the motor through an iron core. The anti-blocking light sewage pump without cooling oil comprises an inverted conical impeller which is not easy to block and a conical funnel-shaped pump body which is easy to expel the granular blockage, which can effectively reduce the problem of pump blocking, avoid the occurrence of the burnout of the motor, and prolong the service life of the pump.

### TECHNICAL FIELD

The application refers to the field of pump, especially refers to an anti-blocking light sewage pump without cooling oil.

### BACKGROUND ART

In Europe and American, the household light sewage pumps are blocked by some foreign matters in the process of use, because the clearance between the impeller and the volute is designed small, when there are some particulates falling in the volute and the pump restarts again, the impeller is easily to be stuck. At the same time, because the impeller and the volute are made of hard material, it's difficult for them to avoid the foreign matters and to be cleaned, thus the motor is burnt out and return.

### Contents of Invention

The main technical problem to be solved in the present application is to provide an anti-blocking light sewage pump without cooling oil, comprising an inverted conical impeller which is not easy to block and a conical funnel-shaped pump body which is easy to expel the granular blockage, which can effectively reduce the problem of pump blocking, avoid the occurrence of the burnout of the motor, and prolong the service life of the pump.

To solove the above technical problem, one technical solution adopted by the present application is to provide an anti-blocking light sewage pump without cooling oil, which comprises a motor housing, a motor, a funnel-shaped pump body, an anti-blocking impeller made of flexible rubber, and a filter screen. The motor and the funnel-shaped pump body are arranged in the motor housing, the anti-blocking impeller made of flexible rubber is arranged in said funnel-shaped pump body, said anti-blocking impeller made of flexible rubber is coaxially connected with the motor through an iron core, an inlet is arranged on the bottom of said funnel-shaped pump body, said filter screen is fixed at the inlet, and an outlet is arranged on the side of said funnel-shaped pump body.

In a preferred embodiment of the present application, said anti-blocking impeller made of flexible rubber has a shape of an inverted cone.

In a preferred embodiment of the present application, the lower surface of said funnel-shaped pump body is a cone less than 90 degrees.

In a preferred embodiment of the present application, a float switch is arranged on the outside of said motor housing, and said float switch is electrically connected with the motor.

The beneficial effects of the present application are as follows: the anti-blocking light sewage pump without cooling oil provided by the present application is designed with an inverted conical impeller which is not easy to block and a conical funnel-shaped pump body which is easy to expel the granular blockage, which can effectively reduce the problem of pump blocking, avoid the occurrence of the burnout of the motor, and prolong the service life of the pump.

### DESCRIPTION OF DRAWINGS

In order to clearly describe the technical solution of the present application, the drawings which are used in the embodiments of the present application are described briefly below. It is obvious that the following described drawings are only some of the embodiments of the invention, those skilled in the art may obtain other drawings according to these drawings without an inventive step, wherein:

FIG. 1 is a structure diagram showing an anti-blocking light sewage pump without cooling oil in accordance with a preferred embodiment of the present application.

FIG. 2 is a structure diagram showing an anti-blocking light sewage pump without cooling oil in accordance with a preferred embodiment of the present application.

### DESCRIPTION OF EMBODIMENTS

The technical solution of the embodiments of the present application will be clearly and completely described. Obviously, the embodiments described herein are some embodiments of the present application, but not all embodiments. Any other embodiments educed by those skilled in the art based on the embodiments described herein without any creative activities should fall into the protection scope of this invention.

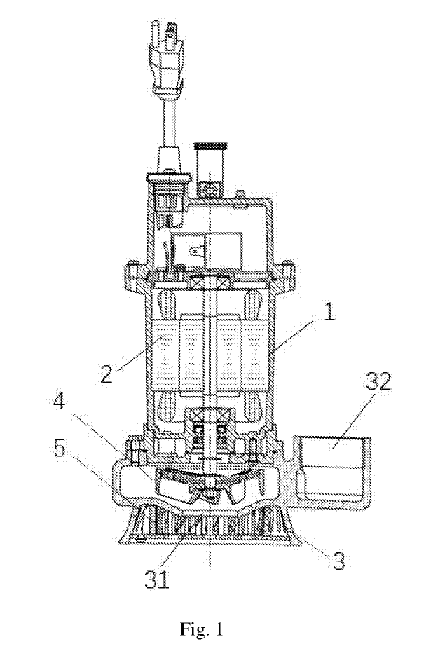

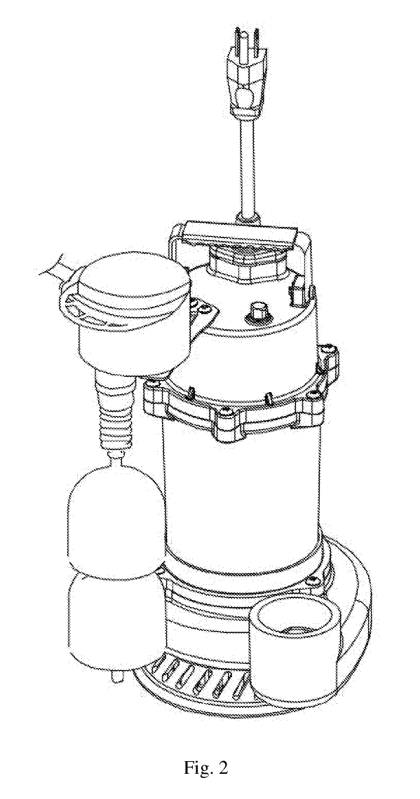

As shown in FIG. 1-2, the embodiment of the present application comprises:

An anti-blocking light sewage pump without cooling oil, which comprises a motor housing 1, a motor 2, a funnel-shaped pump body 3, an anti-blocking impeller 4 made of flexible rubber, and a filter screen 5. The motor 2 and the funnel-shaped pump body 3 are arranged in the motor housing 1, the anti-blocking impeller 4 made of flexible rubber is arranged in said funnel-shaped pump body 3, said anti-blocking impeller 4 made of flexible rubber is coaxially connected with the motor 2 through an iron core, an inlet 31 is arranged on the bottom of said funnel-shaped pump body 3, said filter screen 5 is fixed at the inlet 31, and an outlet 32 is arranged on the side of said funnel-shaped pump body 3.

Wherein said anti-blocking impeller 4 made of flexible rubber has a shape of an inverted cone.

Further, the lower surface of said funnel-shaped pump body 3 is a cone less than 90 degrees.

Further, a float switch is arranged on the outside of said motor housing 1, and said float switch is electrically connected with the motor 2.

When the particulate matters fall in the funnel-shaped pump body 3, the landing spot of the particulate matters is a cone with 0-90 degrees, and the particulate matters slide down alone the cone. When the particulate matters are appeared in the process of pumping, the impeller can flick the particulate matters by means of the deformable characteristics of itself, thus the function of anti-blocking can be achieved.

Above all, the anti-blocking light sewage pump without cooling oil provided by the present application comprises an inverted conical impeller which is not easy to block and a conical funnel-shaped pump body which is easy to expel the granular blockage, which can effectively reduce the problem of pump blocking, avoid the occurrence of the burnout of the motor, and prolong the service life of the pump.

It should be noticed that above embodiments are only examples of the present application but not limitations of patent scope of this invention. All other modifications and variations made according to the description of the present application, or applications used in other relevant technical fields directly or indirectly, should be considered as falling within the patent protection scope of this invention.

1. An anti-blocking light sewage pump without cooling oil, characterized that it comprises a motor housing, a motor, a funnel-shaped pump body, an anti-blocking impeller made of flexible rubber, and a filter screen, the motor and the funnel-shaped pump body are arranged in the motor housing, the anti-blocking impeller made of flexible rubber is arranged in said funnel-shaped pump body, said anti-blocking impeller made of flexible rubber is coaxially connected with the motor through an iron core, an inlet is arranged on the bottom of said funnel-shaped pump body, said filter screen is fixed at the inlet, and an outlet is arranged on the side of said funnel-shaped pump body.

2. An anti-blocking light sewage pump without cooling oil according to claim 1, characterized that said anti-blocking impeller made of flexible rubber has a shape of an inverted cone.

3. An anti-blocking light sewage pump without cooling oil according to claim 1, characterized that the lower surface of said funnel-shaped pump body is a cone less than 90 degrees.

4. An anti-blocking light sewage pump without cooling oil according to claim 1, characterized that a float switch is arranged on the outside of said motor housing, and said float switch is electrically connected with the motor.
